(19) United States
(12) Patent Application Publication
(10) Pub. No.: US 2026/0222782 A1
(43) Pub. Date: Jul. 30, 2026

(54) METHOD AND APPARATUS FOR PROVIDING SERVICE INFORMATION BY USING UWB COMMUNICATION

(71) Applicant: Samsung Electronics Co., Ltd., Suwon-si, Gyeonggi-do (KR)

(72) Inventors: Sooyeon JUNG, Suwon-si (KR); Yeonju LIM, Suwon-si (KR)

(21) Appl. No.: 19/142,816

(22) PCT Filed: Dec. 28, 2022
(86) PCT No.: PCT/KR2022/021547

§ 371 Date: Jun. 24, 2025

(51) Int. Cl. H04W 4/80

(52) U.S. Cl. CPC H04W 4/80

(57) ABSTRACT

A method for operating a first electronic device supporting ultra-wideband (UWB) communication according to an embodiment of the present disclosure may comprise the steps of: receiving a Bluetooth low energy (BLE) advertisement message including an identifier of the first electronic device from a second electronic device; on the basis of the BLE advertisement message, identifying that there is service information displayed on the second electronic device and provided from a third electronic device to the first electronic device; and transmitting a service request message for the service information to the second electronic device.

### CROSS-REFERENCE TO RELATED APPLICATION(S)

This application is a U.S. National Stage application under 35 U.S.C. § 371 of an International application number PCT/KR2022/021547, filed on Dec. 28, 2022, the disclosure of which is incorporated by reference herein in its entirety.

### TECHNICAL FIELD

The disclosure relates to ultra-wideband communication (UWB) and, more particularly, to a method for providing service information using UWB communication.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB). UWB is a wireless communication technology that uses a very wide frequency band of several GHz or more in a baseband without using a wireless carrier.

### DETAILED DESCRIPTION OF THE INVENTION

### Technical Problem

The disclosure proposes a method by which an ultra-wideband (UWB) device provides service information for a target device

### Technical Solution

According to an embodiment of the disclosure, a method for operating a first electronic device supporting ultra-wideband (UWB) communication may comprise receiving, from a second electronic device, a Bluetooth low energy (BLE) advertisement message including an identifier of the first electronic device, identifying whether there is service information displayed on the second electronic device and provided from a third electronic device to the first electronic device based on the BLE advertisement message, and transmitting a service request message for the service information to the second electronic device based on distance information between the first electronic device and the second electronic device obtained through UWB ranging.

According to an embodiment of the disclosure, a method for operating a second electronic device supporting ultra-wideband (UWB) communication may comprise receiving service information to be provided to a first electronic device from a third electronic device through UWB communication, transmitting a Bluetooth low energy (BLE) advertisement message including an identifier of the first electronic device, and receiving a service request message for the service information from the first electronic device in response to the BLE advertisement message. The BLE advertisement message including the identifier of the first electronic device is described as an embodiment, and may include a plurality of electronic device identifiers.

According to an embodiment of the disclosure, a first electronic device supporting ultra-wideband (UWB) communication comprises a transceiver and a controller. The controller may receive, from a second electronic device, a Bluetooth low energy (BLE) advertisement message including an identifier of the first electronic device, identify whether there is service information displayed on the second electronic device and provided from a third electronic device to the first electronic device based on the BLE advertisement message, and control to transmit a service request message for the service information to the second electronic device based on distance information between the first electronic device and the second electronic device obtained through UWB ranging.

According to an embodiment of the disclosure, a second electronic device supporting ultra-wideband (UWB) communication comprises a transceiver and a controller. The controller may receive service information to be provided to a first electronic device from a third electronic device through UWB communication, control to transmit a Bluetooth low energy (BLE) advertisement message including an identifier of the first electronic device, and receive a service request message for the service information from the first electronic device in response to the BLE advertisement message.

### Advantageous Effects

A UWB device according to an embodiment of the disclosure may efficiently provide service information for a target device.

A UWB device according to an embodiment of the disclosure may reduce the power consumption of the UWB device by appropriately turning on/off the UWB module.

### BRIEF DESCRIPTION OF DRAWINGS

FIG. 1 illustrates an example architecture of an electronic device according to an embodiment of the disclosure;

FIG. 2 illustrates a communication system including a plurality of electronic devices according to an embodiment of the disclosure;

FIG. 3 illustrates a method for performing communication by a plurality of electronic devices according to an embodiment of the disclosure;

FIG. 4 illustrates an example for adding and identifying a memo through application execution;

FIG. 5 illustrates another example for adding and identifying a note through application execution;

FIG. 6A illustrates an example in which a first electronic device which intends to leave a note toward a target user (target electronic device) displays a note using a second electronic device according to an embodiment of the disclosure;

FIG. 6B illustrates an example in which a first electronic device which intends to leave a note toward a target user (target electronic device) displays a note using a second electronic device according to an embodiment of the disclosure;

FIG. 7 illustrates an example in which a note is differently displayed depending on a distance between a first electronic device and a second electronic device according to an embodiment of the disclosure;

FIG. 8A illustrates a process of displaying information through UWB communication between a plurality of electronic devices according to an embodiment of the disclosure;

FIG. 8B illustrates a process of displaying information through UWB communication between a plurality of electronic devices according to an embodiment of the disclosure;

FIG. 8C illustrates a process of displaying information through UWB communication between a plurality of electronic devices according to an embodiment of the disclosure;

FIG. 9 illustrates a process of establishing and releasing connection of UWB communication considering a user's intention according to an embodiment of the disclosure;

FIG. 10 is a view illustrating areas which are set differently as a first electronic device approaches a second electronic device according to an embodiment of the disclosure;

FIG. 11 illustrates a process in which a first electronic device transmits a service request to a second electronic device using AoA according to an embodiment of the disclosure;

FIG. 12 is a view illustrating a process in which a first electronic device selects a device for requesting a service using AoA according to an embodiment of the disclosure;

FIG. 13 is a view illustrating a process of determining the mobility of an electronic device using AoA according to an embodiment of the disclosure;

FIG. 14 illustrates a process in which a first electronic device determines the mobility of a second electronic device using AoA according to an embodiment of the disclosure;

FIG. 15 is a view illustrating a process of determining UWB driving using an RSSI threshold according to an embodiment of the disclosure;

FIG. 16 is a view illustrating a process in which an electronic device measures AoA according to an embodiment of the disclosure;

FIG. 17 illustrates a process in which an electronic device performs ranging and AoA according to an embodiment of the disclosure;

FIGS. 18A and 18B are views illustrating a tracking area based on AoA and pattern tracking according to an embodiment of the disclosure;

FIG. 19 illustrates a process in which an electronic device directly determines mobility based on a sensor according to an embodiment of the disclosure;

FIG. 20 illustrates a process of turning off UWB based on ranging and sensing according to an embodiment of the disclosure;

FIG. 21 is a view illustrating a process of determining the mobility of an electronic device based on a sensor according to an embodiment of the disclosure;

FIGS. 22A, 22B, and 22C illustrate an example of a UI according to UWB ranging results between electronic devices according to an embodiment of the disclosure;

FIG. 23 illustrates a process of providing a service notification using a cloud according to an embodiment of the disclosure;

FIG. 24 illustrates a process of detecting a service and an area using an IoT cloud according to an embodiment of the disclosure;

FIG. 25 illustrates a process of detecting approach of an electronic device using a hub according to an embodiment of the disclosure;

FIG. 26 illustrates a process of detecting approach of an electronic device using a Wi-Fi AP according to an embodiment of the disclosure;

FIG. 27 illustrates a process in which an electronic device determines whether to perform UWB communication using Wi-Fi AP connection information according to an embodiment of the disclosure; and

FIG. 28 illustrates a structure of an electronic device according to embodiments of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘electronic device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the electronic device may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the electronic device may include a machine to machine (M2M) terminal and a machine-type communication (MTC) terminal/device, but is not limited thereto. In the disclosure, the electronic device may be referred to as a terminal or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. The NB channel may be a subchannel of one of the candidate UWB channels allocated for UWB communication. Candidate UWB channels allocated for UWB communication may be channels allocated for UWB communication defined in IEEE 802.15.4/4z. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message.

When determined to make the subject matter of the present invention unnecessarily unclear, the detailed description of related known functions or features may be skipped in describing the disclosure.

Hereinafter, various embodiments of the disclosure are described with reference to the accompanying drawings.

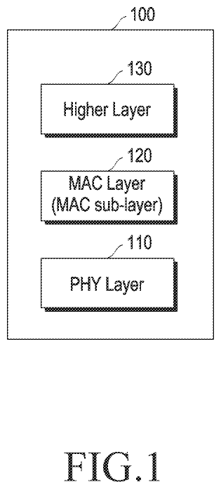

FIG. 1 illustrates an example architecture of an electronic device according to an embodiment of the disclosure.

In the disclosure, the electronic device may be one of various types of electronic devices. For example, the electronic device may be a portable device (e.g., a UE, a smartphone, a wearable device, a vehicle, or a tag device) or a stationary device (e.g., a door lock or an anchor device).

Referring to FIG. 1, the electronic device 100 may include a PHY layer 110, a MAC layer (MAC sublayer) 120, and/or a higher layer 130.

### (1) PHY Layer

The PHY layer 110 may include a low-level control entity and at least one transceiver. In this disclosure, the transceiver may be referred to as an RF transceiver or a radio transceiver.

As an embodiment, at least one transceiver may include a first transceiver supporting UWB communication (e.g., 802.15.4z-based UWB communication), a second transceiver supporting NB communication using a narrower bandwidth than that of UWB communication, and/or a third transceiver supporting other communication technologies (e.g., Bluetooth or BLE). In this disclosure, the first transceiver may be referred to as a UWB transceiver. The second transceiver may be referred to as an NB transceiver. The third transceiver may be referred to as an OOB transceiver. According to embodiments, one transceiver may support a plurality of communication technologies. For example, one transceiver may support UWB communication and NB communication.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC Layer

The MAC layer 120 provides an interface between the upper layer 130 and the PHY layer 120.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)
In an embodiment, the MAC layer 120 may support at least one of the following functions.
Device discovery and connection setup function
Channel access function (function of access to physical channel (e.g., NB channel/UWB channel/OOB channel))
Synchronization function
Interference mitigation function based on energy detection
Functions related to NB signaling
Guaranteed timeslot (GTS) management function
Frame delivery function
UWB ranging function
PHY parameter change notification function
Security function

### (3) Upper Layer

The upper layer 130 may include a network layer providing functions, such as network configuration and message routing, and/or an application layer providing an intended function of the device. In an embodiment, the application layer may be a UWB-enabled application layer for providing a UWB service.

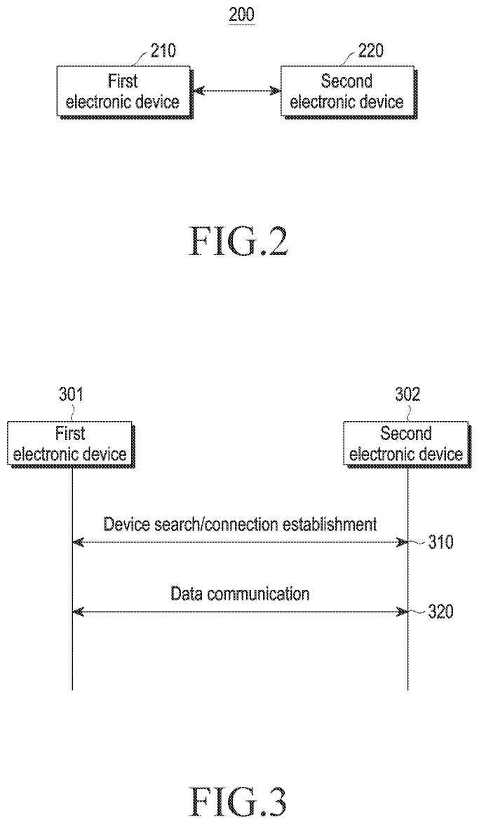

FIG. 2 illustrates a communication system including a plurality of electronic devices according to an embodiment of the disclosure.

Referring to FIG. 2, a communication system 200 may include a first electronic device 210 and a second electronic device 220. As an embodiment, the first electronic device 210 and/or the second electronic device 220 may be the electronic device 100 of FIG. 1.

The first electronic device 210 may communicate with the second electronic device 220 for device discovery, connection setup, ranging (e.g., UWB ranging), data communication, and/or other purposes.

The first electronic device 210 may communicate with the second electronic device 220 according to a preset communication scheme (technology). For example, the first electronic device 210 may perform wireless communication with the second electronic device 220 using a UWB communication scheme, an NB communication scheme, and/or an OOB communication scheme.

In the disclosure, the UWB communication scheme may perform communication through at least one of candidate UWB channels allocated for WB communication.

NB communication may support at least one NB channel having a narrower bandwidth than the UWB channel. According to an embodiment, the NB channel may be a subchannel of one of the candidate UWB channels allocated for UWB communication.

FIG. 3 illustrates a method for performing communication by a plurality of electronic devices according to an embodiment of the disclosure.

The first electronic device 301 and the second electronic device 302 of FIG. 3 may be, e.g., the electronic devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controllee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.
Transaction operation: An operation in which an electronic device exchanges service data with another electronic device.

Meanwhile, an electronic device (e.g., a refrigerator, a washer, an air conditioner, or other home appliances) with a display, such as a family hub, may support the function of displaying information (e.g., a note) provided by an external electronic device (e.g., a mobile phone, a mobile device, or a tablet PC).

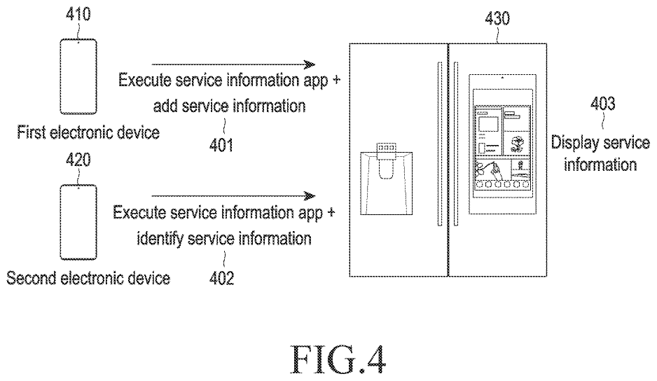

FIG. 4 illustrates an example for adding and identifying a memo through application execution.

Referring to FIG. 4, the first electronic device 410 (e.g., a mobile phone) may display the service information (e.g., a note) to be provided to the second electronic device 420 (e.g., a mobile phone) on the third electronic device 430 (e.g., a refrigerator).

In operation 401, the first electronic device 410 may execute the application capable of managing and/or processing the service information, and may add (or generate) the service information (e.g., a note) to be provided to the second electronic device 420 on the executed application.

In operation 402, the second electronic device 420 may execute the application capable of managing and/or processing the service information, and identify the service information (e.g., a note) added (or generated) by the first electronic device 410 on the executed application. According to an embodiment, the application executed in the first electronic device 410 and the application executed in the second electronic device 420 may be the same. When the user of the second electronic device 420 identifies that there is the service information (e.g., a note) added (or generated) by the first electronic device 410 on the application, the user may recognize that the service information (e.g., a note) is to be displayed on the third electronic device 430.

According to an embodiment, the service information (e.g., a note) identifying operation of the second electronic device 420 illustrated in operation 402 may be omitted.

In operation 403, the third electronic device 430 may display the service information (e.g., a note) added (or generated) by the first electronic device 410. According to an embodiment, the third electronic device 430 may display the service information (e.g., a note) added (or generated) by the first electronic device 410 continuously or for a preset time. According to an embodiment, the third electronic device 430 may display the service information (e.g., a note) added (or generated) by the first electronic device 410 based on a request from the first electronic device 410 and/or the second electronic device 420.

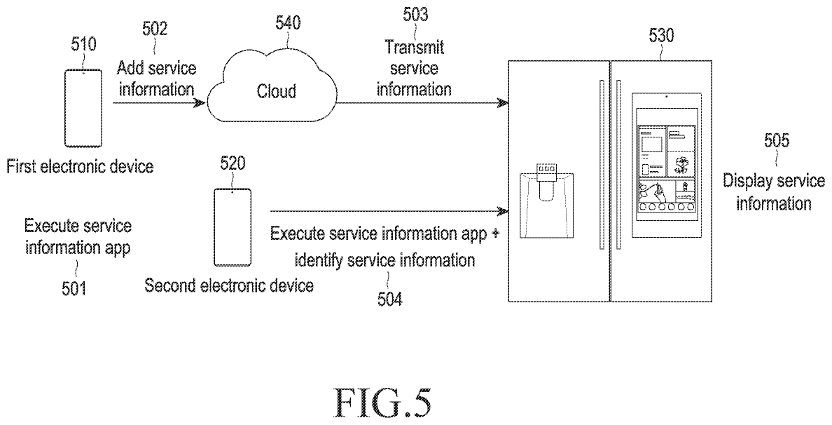

FIG. 5 illustrates another example for adding and identifying a note through application execution.

Referring to FIG. 5, the first electronic device 510 (e.g., a mobile phone) may display service information (e.g., a note) to be provided to the second electronic device 520 (e.g., a mobile phone) on the third electronic device 530 (e.g., a refrigerator) through the cloud 540. According to an embodiment, the cloud 540 may include a server for supporting an Internet of Things (IoT) environment, and may communicate with at least one of the first electronic device 510 to the third electronic device 530.

In operation 501, the first electronic device 510 may execute an application capable of managing and/or processing service information and, in operation 502, the first electronic device 510 may add (or generate) service information (e.g., a note) to be provided to the second electronic device 520 on the executed application and transmit it to the cloud 540.

In operation 503, the cloud 540 may transmit service information (e.g., a note) received from the first electronic device 510 to the third electronic device 530.

In operation 504, the second electronic device 520 may execute an application capable of managing and/or processing service information, and identify service information (e.g., a note) added (or generated) by the first electronic device 510 on the executed application. According to an embodiment, the application executed in the first electronic device 510 and the application executed in the second electronic device 520 may be the same. When the user of the second electronic device 520 identifies that there is service information (e.g., a note) added (or generated) by the first electronic device 510 on the application, the user may recognize that the service information (e.g., a note) will be displayed on the third electronic device 530.

According to an embodiment, the service information (e.g., a note) identifying operation of the second electronic device 520 illustrated in operation 504 may be omitted.

In operation 505, the third electronic device 530 may display the service information (e.g., a note) added (or generated) by the first electronic device 510. According to an embodiment, the third electronic device 530 may display the service information (e.g., a note) added (or generated) by the first electronic device 510 continuously or for a preset time. According to an embodiment, the third electronic device 530 may display the service information (e.g., a note) added (or generated) by the first electronic device 510 based on a request from the first electronic device 510, the second electronic device 520, and/or the cloud 540.

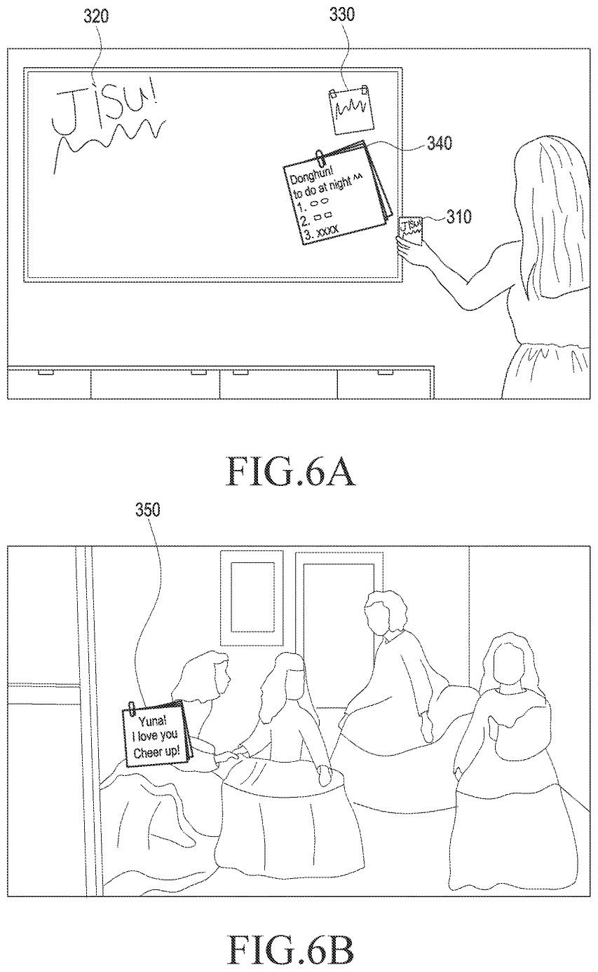

FIG. 6A illustrates an example in which a first electronic device which intends to leave a note toward a target user (target electronic device) displays a note using a second electronic device according to an embodiment of the disclosure.

Referring to FIG. 6A, when a note 310 is input (or written) to the first electronic device (e.g., a mobile phone) and the first electronic device (e.g., a mobile phone) is located in a set distance and/or angle from the second electronic device (e.g., a TV), the same note 320 input to the first electronic device (e.g., a mobile phone) may be displayed on the display of the second electronic device (e.g., a TV). For example, when the first electronic device points to the setting area of the second electronic device by the user pointing operation (e.g., determining based on an angle of arrival (AoA) measurement), the second electronic device may display a note received from the first electronic device.

The second electronic device may display the notes 330 and 340 input from at least one other electronic device in another area in addition to the note 320 input from the first electronic device. According to an embodiment, the second electronic device may display the notes 320 to 340 input from different electronic devices, and display the corresponding note when the target electronic device for the corresponding note approaches the second electronic device.

FIG. 6B illustrates an example in which a first electronic device which intends to leave a note toward a target user (target electronic device) displays a note using a second electronic device according to an embodiment of the disclosure.

Referring to FIG. 6B, the first electronic device (e.g., a mobile phone) and the second electronic device (e.g., a TV) may be connected to display the screen of the first electronic device (e.g., a mobile phone) on the second electronic device (e.g., a TV).

The note input by the first electronic device (e.g., a mobile phone) may be displayed as the same note 350 on the display of the second electronic device (e.g., a TV).

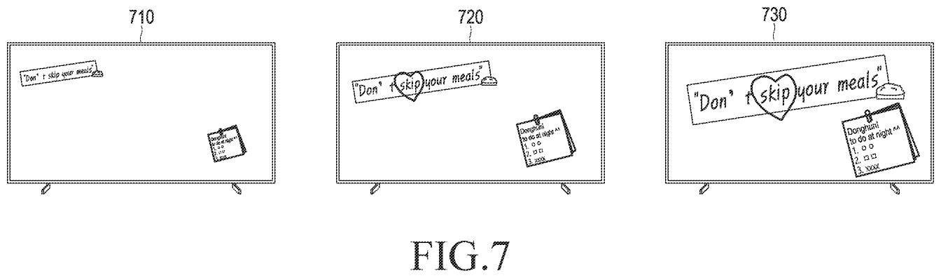

FIG. 7 illustrates an example in which a note is differently displayed depending on a distance between a first electronic device and a second electronic device according to an embodiment of the disclosure.

Referring to FIG. 7, the first electronic device (e.g., a mobile phone) may add (or generate) a note on the application (e.g., a note app) for the service information by user input. When the first electronic device (e.g., a mobile phone) points at and/or approaches the second electronic device (e.g., a TV), a note added (or generated) by the first electronic device (e.g., a mobile phone) may be transmitted to the second electronic device (e.g., a TV). When the first electronic device (e.g., a mobile phone) points at and/or approaches the second electronic device (e.g., a TV), a note added (or generated) by the first electronic device (e.g., a mobile phone) may be displayed on the second electronic device (e.g., a TV).

The display size of the note of the first electronic device (e.g., a mobile phone) displayed on the second electronic device (e.g., a mobile phone) may be set differently according to the distance between the first electronic device (e.g., a mobile phone) and the second electronic device (e.g., a TV). For example, as the distance between the first electronic device (e.g., a mobile phone) and the second electronic device (e.g., a TV) decreases, the note of the first electronic device (e.g., a mobile phone) displayed on the second electronic device (e.g., a TV) may be displayed in a larger size (710→720→730).

The disclosure proposes a method by which a device (e.g., a TV or display device) acting as a UWB anchor in a D-to-D (device to device) connection receives and/or stores content for the customer device distinctly for each external UWB device (e.g., a terminal). The disclosure proposes a method by which a device acting as a UWB anchor may recognize whether another UWB device approaches within a specific distance and determine content corresponding to the specific UWB device and display the same.

The disclosure proposes a method by which a terminal having a UWB module in an IoT environment, when using a UWB ranging-based function/service through interworking with various home appliances, reduces power consumption due to use of the UWB module.

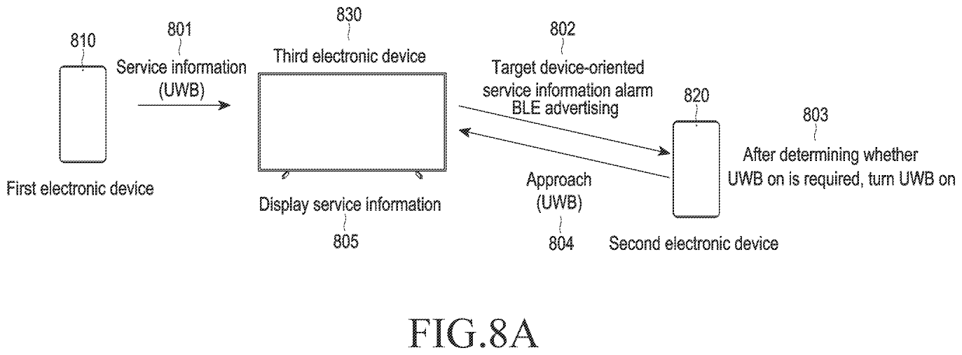

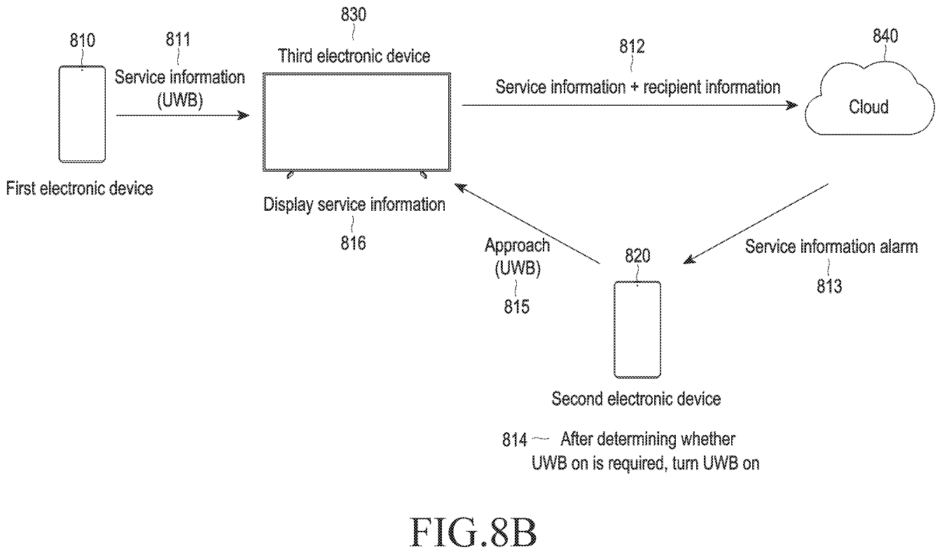

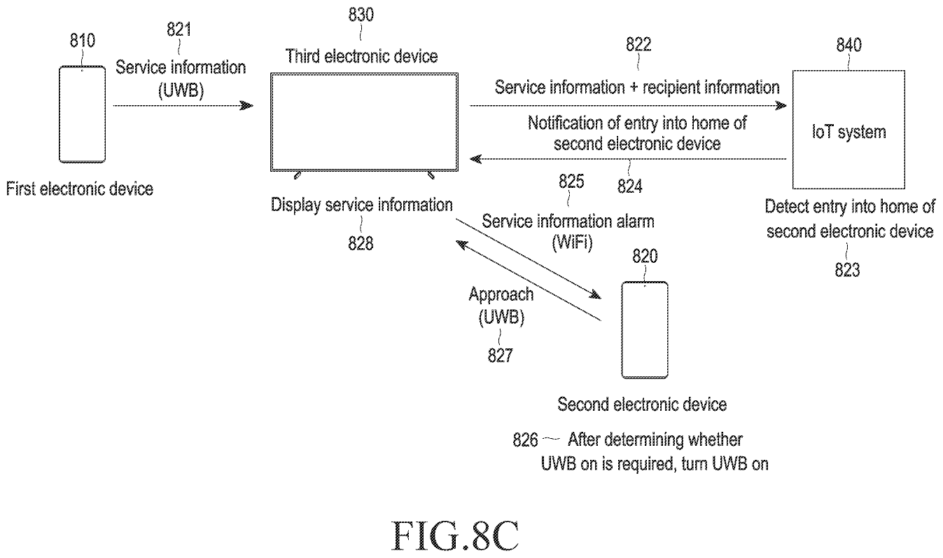

FIG. 8A illustrates a process of displaying information through UWB communication between a plurality of electronic devices according to an embodiment of the disclosure.

Referring to FIG. 8A, in operation 801, the first electronic device 810 may transmit the service information (e.g., a note) to the third electronic device 830 through UWB communication. In operation 802, the third electronic device 830 may transmit a target device-oriented the service information alarm through BLE advertising.

The second electronic device 820 receiving the target device-oriented the service information alarm through BLE advertising may determine whether to turn on the UWB module in operation 803, and may turn on the UWB module when UWB communication with the third electronic device 830 is required.

In operation 804, the third electronic device 830 may identify that the second electronic device 820 is located in a close distance through UWB communication (or UWB ranging) with the second electronic device 820.

In operation 805, the third electronic device 830 may display the service information (e.g., a note) generated by the first electronic device 810 so that the user of the second electronic device 820 may see it.

FIG. 8B illustrates a process of displaying information through UWB communication between a plurality of electronic devices according to an embodiment of the disclosure.

Referring to FIG. 8B, in operation 811, the first electronic device 810 may transmit the service information (e.g., a note) to the third electronic device 830 through UWB communication. In operation 812, the third electronic device 830 may transmit the service information and recipient information to the cloud 840.

In operation 813, the cloud 840 may transmit an alarm for the service information to the second electronic device 820. The second electronic device 820 receiving the service information alarm may determine whether to turn on the UWB module in operation 814, and may turn on the UWB module when UWB communication with the third electronic device 830 is required.

In operation 815, the third electronic device 830 may identify that the second electronic device 820 is located in a close distance through UWB communication (or UWB ranging) with the second electronic device 820.

In operation 816, the third electronic device 830 may display the service information (e.g., a note) generated by the first electronic device 810 so that the user of the second electronic device 820 may see it.

FIG. 8C illustrates a process of displaying information through UWB communication between a plurality of electronic devices according to an embodiment of the disclosure.

Referring to FIG. 8C, in operation 821, the first electronic device 810 may transmit the service information (e.g., a note) to the third electronic device 830 through UWB communication. In operation 822, the third electronic device 830 may transmit the service information and recipient information to the IoT system 840. According to an embodiment, the IoT system 840 may include at least one of a cloud, an AP, and a hub.

In operation 823, the IoT system 840 may detect entry into the home of the second electronic device 820. In operation 824, the IoT system 840 may transmit a home entry notification of the second electronic device 820 to the third electronic device 830.

In operation 825, the third electronic device 830 may transmit a notification for the service information to the second electronic device 820 through Wi-Fi. The second electronic device 820 receiving the service information notification may determine whether to turn on the UWB module in operation 826, and may turn on the UWB module when UWB communication with the third electronic device 830 is required.

In operation 827, the third electronic device 830 may identify that the second electronic device 820 is located in a close distance through UWB communication (or UWB ranging) with the second electronic device 820.

In operation 828, the third electronic device 830 may display the service information (e.g., a note) generated by the first electronic device 810 so that the user of the second electronic device 820 may see it.

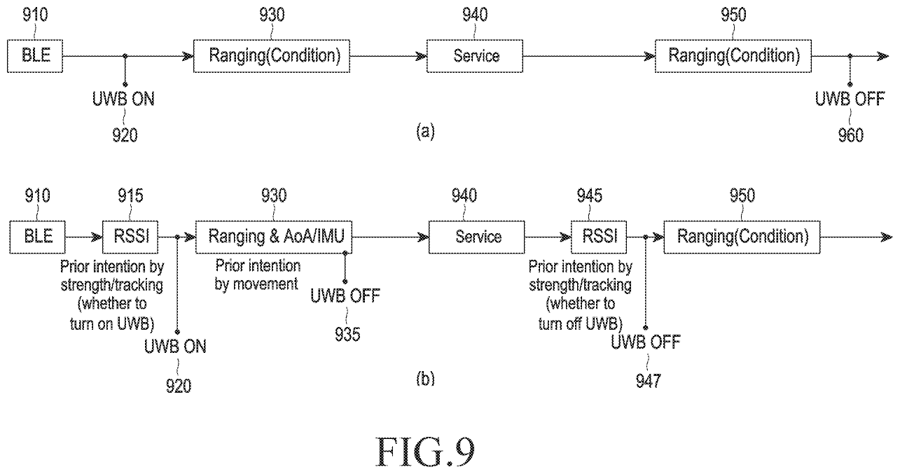

FIG. 9 illustrates a process of establishing and releasing connection of UWB communication considering a user's intention according to an embodiment of the disclosure.

The electronic device may determine the user intention based on the mobility of the electronic device using at least one of an angle of arrival (AoA), a received signal strength indicator (RSSI), and sensing information. The electronic device may control UWB communication connection and/or release by determining the user intention based on mobility. In order to solve the power consumption issue with the electronic device due to frequent/long UWB communication connection and/or release, the electronic device may perform the UWB communication connection as late as possible and perform the UWB disconnection as soon as possible in consideration of the user's intention.

Referring to FIG. 9(a), the electronic device may turn on the UWB module 920 based on Bluetooth low energy (BLE) communication 910. According to an embodiment, the electronic device performs UWB ranging (930) (Ranging (Condition), and may provide or receive a service through a UWB ranging result and UWB communication (940). According to an embodiment, the electronic device may perform UWB ranging (950) after the service, and may turn off the UWB module 960 based on the UWB ranging result.

Referring to FIG. 9(b), the electronic device may turn on (920) the UWB module based on Bluetooth low energy (BLE) communication 910 and RSSI value 915. The electronic device may determine the user's intention of the electronic device based on tracking information about the RSSI value 915 and/or the RSSI value 915, and may turn on the UWB module 920 according to the determination result.

The electronic device may determine the mobility of the electronic device in consideration of at least one 930 of UWB ranging, AoA measurement, and measurement using an inertial measurement unit (IMU) sensor, and may determine the user intention according to the mobility. According to an embodiment, the electronic device may turn off (935) the UWB module according to a result of determining user intention according to mobility.

According to an embodiment, the IMU sensor may include at least one of an acceleration sensor, an acceleration sensor, and a magnetometer.

The electronic device may provide or receive a service through UWB communication (940). According to an embodiment, when the UWB module is not turned off in operation 935, the electronic device may determine the intention of the user of the electronic device based on the RSSI value 945 and/or tracking information about the RSSI value 945, and may turn the UWB module off (947) according to the determination result. According to an embodiment, the electronic device may perform UWB ranging (950) after the service, and may turn off the UWB module based on the UWB ranging result.

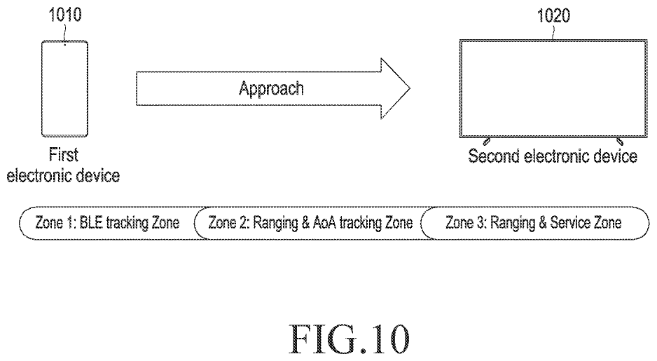

FIG. 10 is a view illustrating areas which are set differently as a first electronic device approaches a second electronic device according to an embodiment of the disclosure.

Referring to FIG. 10, as the first electronic device 1010 (e.g., a mobile phone) approaches the second electronic device 1020 (e.g., a TV), areas (zones 1 to 3) may be set differently.

When the first electronic device 1010 approaches the second electronic device 1020 and the distance between the first electronic device 1010 and the second electronic device 1020 is larger than the first threshold, the first electronic device 1010 may be determined to be located in Zone 1 (a BLE tracking zone). According to an embodiment, the first electronic device 1010 may determine whether the first electronic device 1010 is located in Zone 1 (BLE tracking zone) in consideration of BLE RSSI tracking and a threshold.

When the first electronic device 1010 approaches the second electronic device 1020, and the distance between the first electronic device 1010 and the second electronic device 1020 is smaller than the first threshold and larger than the second threshold, the first electronic device 1010 may be determined to be located in Zone 2 (ranging & AoA tracking zone).

According to an embodiment, at least one of the first electronic device 1010 and the second electronic device 1020 may perform UWB period adjustment and/or UWB power control in Zone 2 (ranging & AoA tracking zone). According to an embodiment, at least one of the first electronic device 1010 and the second electronic device 1020 may adjust the UWB period using UWB ranging and/or IMU sensor.

According to an embodiment, in Zone 2 (ranging & AoA tracking zone), the second electronic device 1020 may measure AoA with the first electronic device 1010. According to an embodiment, when the AoA measurement value with the first electronic device 1010 measured in the second electronic device 1020 exceeds the AoA threshold, the second electronic device 1020 may transmit a UWB off identification to the first electronic device 1010.

When the first electronic device 1010 approaches the second electronic device 1020 and the distance between the first electronic device 1010 and the second electronic device 1020 is smaller than the second threshold, the first electronic device 1010 may be determined to be located in Zone 3 (ranging & service zone). According to an embodiment, in Zone 3 (ranging & service zone), the second electronic device 1020 may adjust the content and/or size of the user interface (UI) according to a ranging result.

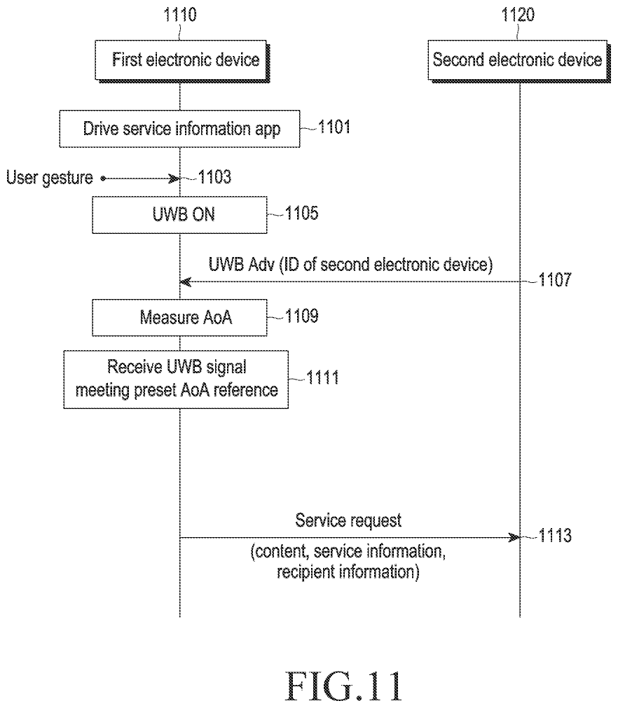

FIG. 11 illustrates a process in which a first electronic device transmits a service request to a second electronic device using AoA according to an embodiment of the disclosure.

In FIG. 11, the first electronic device 1110 may use UWB AoA to specify and select an electronic device to transmit the generated the service information (e.g., a note).

Referring to FIG. 11, in operation 1101, the first electronic device 1110 may drive the application for managing and/or processing the service information. In operation 1103, the first electronic device 1110 may detect the user gesture. For example, the user gesture may be to slide a note (or memo) written by the first electronic device 1110 toward the TV, press and slide the written note (memo), or enter the “post it attach” button through the “share” menu in the written note (memo).

According to the user gesture detection result of the first electronic device 1110, the first electronic device 1110 may turn on the UWB module in operation 1105.

In operation 1107, the second electronic device 1120 may transmit a UWB advertisement message including the ID of the second electronic device 1120 to the first electronic device 1110. In operation 1109, the first electronic device 1110 may measure AoA and receive a UWB signal that meets a preset AoA reference in operation 1111. For example, the predetermined AoA reference may be “−10°<AoA value<10°”.

In operation 1113, the first electronic device 1110 may transmit a service request including at least one of content, the service information, and recipient information to the second electronic device 1120.

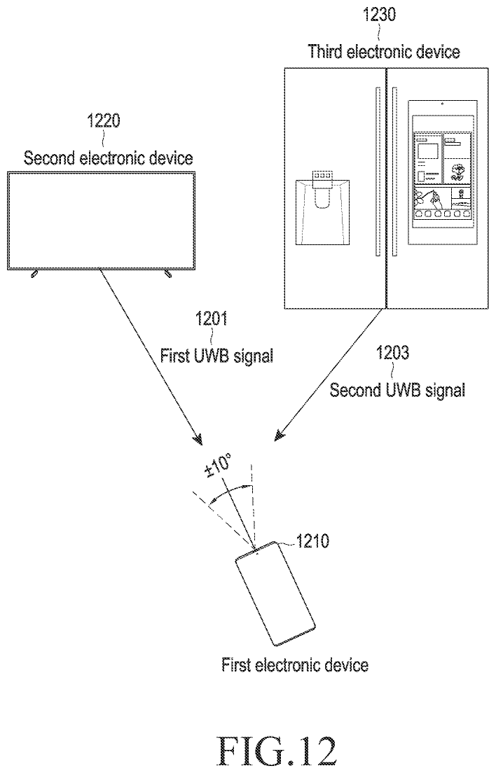

FIG. 12 is a view illustrating a process in which a first electronic device selects a device for requesting a service using AoA according to an embodiment of the disclosure.

Referring to FIG. 12, the predetermined AoA reference of the first electronic device 1210 (e.g., a mobile phone) may be set to, e.g., “−10°<AoA value<10°”.

The first electronic device 1210 may receive the first UWB signal 1201 from the second electronic device 1220 (e.g., a TV), and the first UWB signal 1201 may satisfy a predetermined AoA reference. The first electronic device 1210 may receive the second UWB signal 1203 from the third electronic device 1230 (e.g., a refrigerator), and the second UWB signal 1203 may not meet a preset AoA reference.

Since the first UWB signal 1201 meets the preset AoA reference, the first electronic device 1210 may select the second electronic device 1220 as a device for requesting a service.

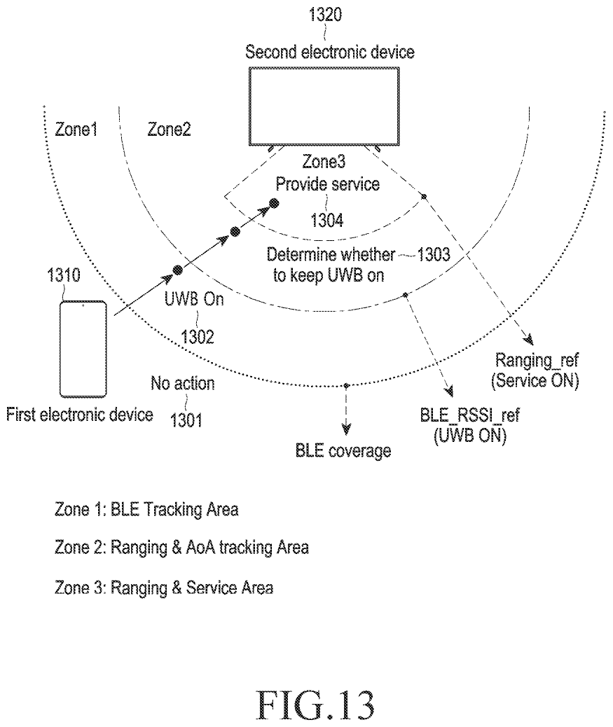

FIG. 13 is a view illustrating a process of determining the mobility of an electronic device using AoA according to an embodiment of the disclosure.

Referring to FIG. 13, the first electronic device 1310 may determine the mobility of the first electronic device 1310 using BLE, and the second electronic device 1320 may determine the mobility of the first electronic device 1310 using AoA and/or ranging.

Zone1 to Zone3 may be defined with respect to the second electronic device 1320 that provides the service information (e.g., a note), and UWB on/off and service may be performed according to the determination of whether to enter each zone based on the mobility of the first electronic device 1310.

In operation 1301, if the BLE RSSI does not meet the setting reference, the first electronic device 1310 may determine that the first electronic device 1310 is located outside the BLE coverage, and may not take any action (no action).

In operation 1302, when the BLE RSSI meets the setting reference, the first electronic device 1310 may determine that the first electronic device 1310 is located in Zone 1 (BLE tracking area), and may turn on the UWB module. According to an embodiment, the first electronic device 1310 may determine whether to turn on the UWB module through BLE RSSI tracking.

In operation 1303, when the first electronic device 1310 is located in Zone 2 (ranging & AoA tracking area), the first electronic device 1310 and the second electronic device 1320 may detect the approach of the first electronic device 1310 to the second electronic device 1320 and the movement direction of the first electronic device 1310 using UWB ranging and AoA, and determine whether to maintain UWB communication according to the detection result.

For example, if it is determined that the first electronic device 1310 is entering the front of the second electronic device 1320 as a result of UWB ranging and AoA measurement, the possibility of the second electronic device 1320 providing a service to the first electronic device 1310 may increase (UWB maintained).

For example, if it is determined that the first electronic device 1310 is walking around the second electronic device 1320 as a result of UWB ranging and AoA measurement, the possibility of the second electronic device 1320 providing a service to the first electronic device 1310 may be decreased (UWB maintained).

For example, if the first electronic device 1310 moves toward the side where the screen of the second electronic device 1320 is not visible or moves away as a result of UWB ranging and AoA measurement, there may be no possibility that the second electronic device 1320 is to provide a service to the first electronic device 1310 (UWB Off).

For example, if the first electronic device 1310 is located on the side where the screen of the second electronic device 1320 is not visible as a result of UWB ranging and AoA measurement, there may be no possibility that the second electronic device 1320 provides a service to the first electronic device 1310 (UWB Off).

In operation 1304, when the first electronic device 1310 is located in Zone 3 (ranging & service area), the second electronic device 1320 may provide a service to the first electronic device 1310. According to an embodiment, the second electronic device 1320 may provide a customized UI for each distance for at least one approaching device.

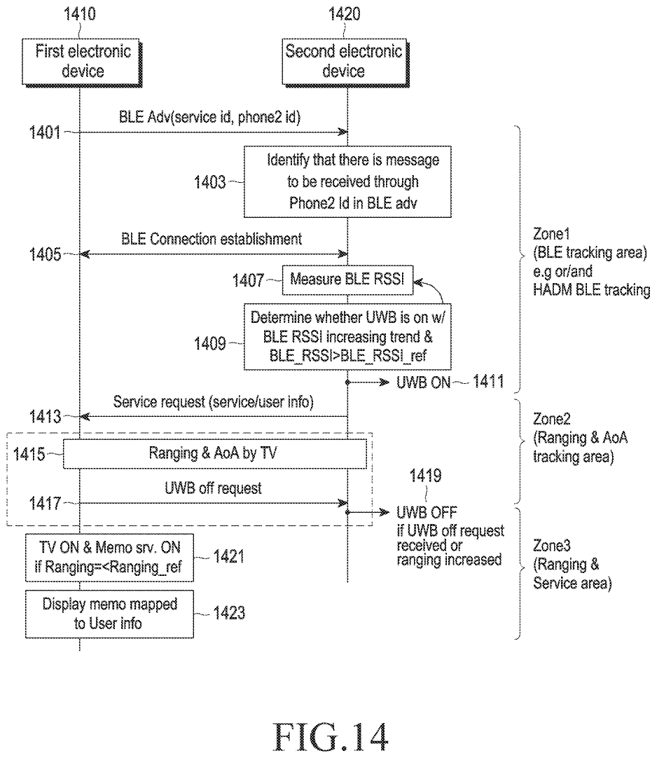

FIG. 14 illustrates a process in which a first electronic device determines the mobility of a second electronic device using AoA according to an embodiment of the disclosure.

Referring to FIG. 14, in operation 1401, the first electronic device 1410 (e.g., a TV) may transmit a BLE advertisement message including a service id and a phone2 id to the second electronic device (e.g., a mobile phone). According to an embodiment, the phone2 id may be an identifier for the second electronic device (e.g., a mobile phone). According to an embodiment, the BLE advertisement message may include a recipient list. According to an embodiment, a plurality of BLE advertisement messages may be used.

In operation 1403, the first electronic device 1410 may identify that there is a message to be received through the phone2 id included in the BLE advertisement message.

In operation 1405, the first electronic device 1410 may perform a BLE connection establishment with the second electronic device 1420.

In operation 1407, the second electronic device 1420 may measure the BLE RSSI. In operation 1409, the second electronic device 1420 may determine whether to turn on the UWB module according to an increasing trend of the BLE RSSI and whether the BLE RSSI value BLE_RSSI exceeds the threshold BLE_RSSI_ref. According to an embodiment, operations 1407 and 1409 may be performed even before the BLE connection establishment operation 1405. In operation 1411, the second electronic device 1420 may turn on the UWB module.

According to an embodiment, operations 1401 to 1411 may be performed when the second electronic device 1420 is located in Zone 1 (BLE tracking area).

In operation 1413, the second electronic device 1420 may transmit a service request including the service information or user information or identifier information about the second electronic device 1420 to the first electronic device 1410. According to an embodiment, the second electronic device 1420 may trigger UWB ranging while transmitting a service request to the first electronic device 1410.

In operation 1415, the first electronic device 1410 may perform ranging and AoA. According to an embodiment, operation 1415 may be performed when the second electronic device 1420 is located in Zone 2 (ranging & AoA tracking area).

According to an embodiment, in operation 1417, the first electronic device 1410 may transmit a UWB off request to the second electronic device 1420. According to an embodiment, the first electronic device 1410 may perform ranging tracking during a predetermined AoA (or AoA pattern).

In operation 1419, when the second electronic device 1420 may receive a UWB off request from the first electronic device or the ranging value measured by the second electronic device 1420 increases, the second electronic device 1420 may turn off the UWB module.

In operation 1421, when the ranging value with the second electronic device 1420 is smaller than or equal to the threshold Ranging_ref, the first electronic device 1410 may turn on the display and display the service information (e.g., a note).

In operation 1423, the first electronic device 1410 may display the service information (e.g., a note) mapped to the user information on the display. According to an embodiment, the user information may be the same as that transmitted from the second electronic device 1420 in operation 1413.

According to an embodiment, operations 1421 and 1423 may be performed when the second electronic device 1420 is located in Zone 3 (ranging & service area).

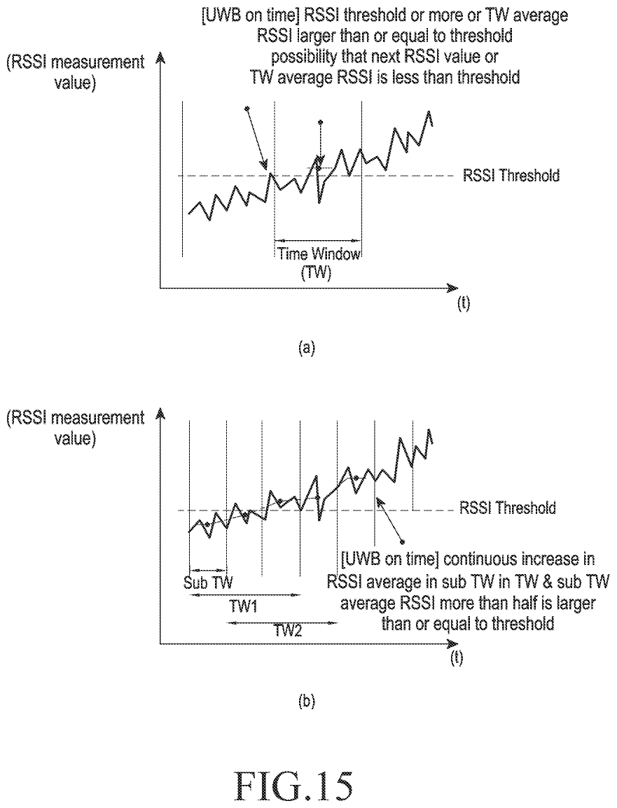

FIG. 15(a) is a view illustrating a process of determining UWB driving using an RSSI threshold according to an embodiment of the disclosure.

Referring to FIG. 15(a), the electronic device may determine whether to turn on the UWB module using the RSSI measurement value and RSSI threshold.

The electronic device may turn on the UWB module when the RSSI measurement value is larger than or equal to the RSSI threshold or when a time window (TW) average RSSI value is larger than or equal to the RSSI threshold.

However, if the electronic device may determine whether to drive the UWB module using only the RSSI measurement value and RSSI threshold, there may be a possibility that the next RSSI value or the next TW average RSSI is less than the RSSI threshold after determining to turn on the UWB module.

FIG. 15(b) is a view illustrating a process of determining UWB driving using an RSSI threshold and an RSSI tracking value according to an embodiment of the disclosure.

The electronic device may turn on the UWB module when the RSSI average value in the sub TW in the time window (TW) continues to increase and the sub TW average RSSI exceeding the majority is larger than or equal to the RSSI threshold. According to an embodiment, the electronic device may track the RSSI value according to various implementation methods.

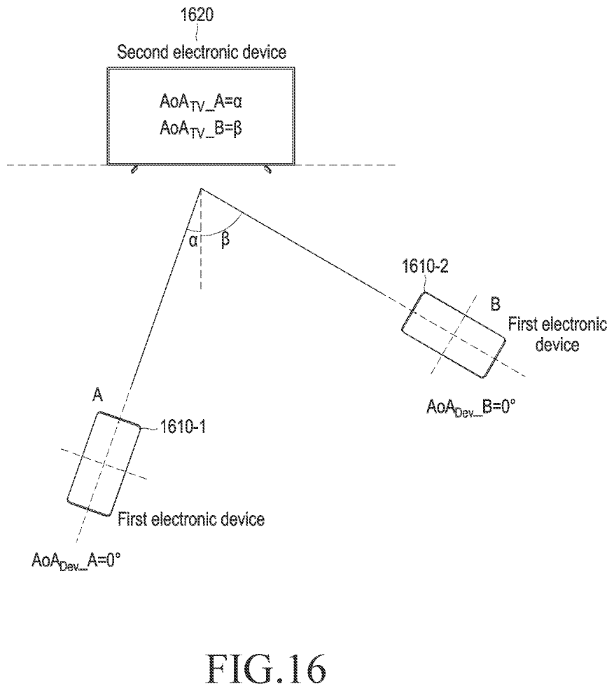

FIG. 16 is a view illustrating a process in which an electronic device measures AoA according to an embodiment of the disclosure.

Referring to FIG. 16, a second electronic device 1620 (e.g., a TV) that is fixed at a specific position and provides a service (or the service information) may measure AoA for first electronic devices 1610-1 and 1610-2 (e.g., mobile phones) which are movable.

The second electronic device 1620 may determine AoA for the first electronic device 1610-1 as α based on a relative position to the first electronic device 1610-1 (AoA_{TV}_A=α). The second electronic device 1620 may determine AoA for the first electronic device 1610-2 as β based on a relative position to the first electronic device 1610-2 (AoA_{TV}_B=β).

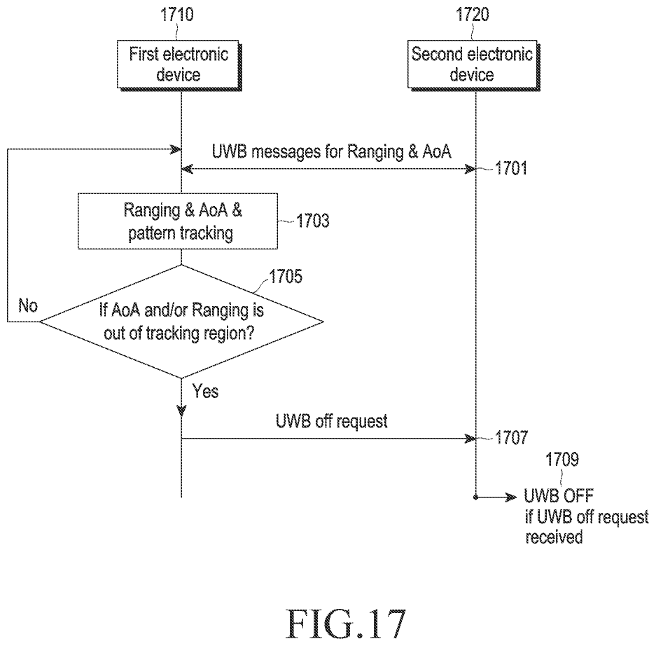

FIG. 17 illustrates a process in which an electronic device performs ranging and AoA according to an embodiment of the disclosure.

Referring to FIG. 17, in operation 1701, the first electronic device 1710 (e.g., a TV) and the second electronic device 1720 (e.g., a mobile phone) may transmit and/or receive UWB message(s) for ranging and AoA.

In operation 1703, the first electronic device 1710 may perform ranging, AoA, and pattern tracking.

In operation 1705, the first electronic device 1710 may determine whether AoA and/or ranging are out of a tracking area (tracking region). According to an embodiment, when AoA and/or ranging does not fall outside the tracking area, the first electronic device 1710 may repeatedly perform operations 1701 and/or 1703.

According to an embodiment, when AoA and/or ranging are out of the tracking area, the first electronic device 1710 may transmit a UWB off request to the second electronic device 1720 in operation 1707. According to an embodiment, the UWB off request may be transmitted through BLE, Wi-Fi, or UWB. According to an embodiment, the UWB off request may be variously referred to by other various terms, such as AoA notification or service denial.

In operation 1709, the second electronic device 1720 receiving the UWB off request may turn off the UWB module.

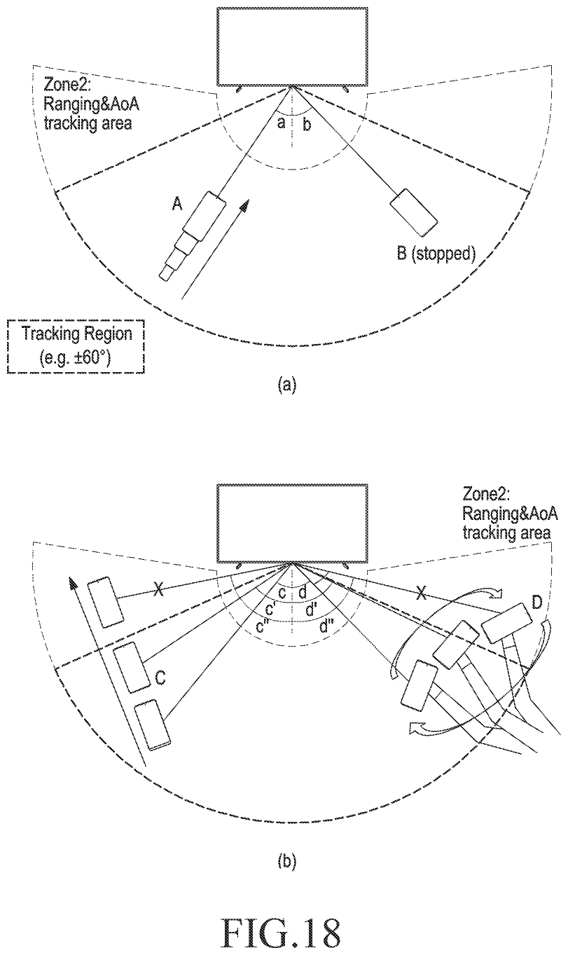

FIGS. 18A and 18B are views illustrating a tracking area based on AoA and pattern tracking according to an embodiment of the disclosure.

Referring to FIG. 18A, when the first electronic device A approaches the second electronic device (e.g., a TV) in Zone 2 (ranging & AoA tracking area), the AoA value AoA_{TV}_A may maintain an approximate value, and the ranging value Ranging_{TV}_A may gradually decrease. According to an embodiment, when the first electronic device A approaches the second electronic device (e.g., a TV), the first electronic device A may stay in the tracking area. The second electronic device (e.g., a TV) may track AoA for the first electronic device A and its pattern in the tracking area.

Referring to FIG. 18A, when the first electronic device B is stopped in Zone 2 (ranging & AoA tracking area), the AoA value AoA_{TV}_B may maintain a constant value, and the Ranging_{TV}_B may also maintain a constant value. According to an embodiment, when the first electronic device B is stopped, the first electronic device B may stay in the tracking area, and the ranging interval may be adjusted. The second electronic device (e.g., a TV) may track AoA and its pattern for the wp1 electronic device B in the tracking area.

Referring to FIG. 18B, when the first electronic device C moves so that the AoA with the second electronic device (e.g., a TV) increases in Zone 2 (ranging & AoA tracking area), the AoA value AoA_{TV}_C may increases gradually (c→c′→c″), and the ranging value Ranging_{TV}_C may be flexibly varied. According to an embodiment, when the first electronic device C moves so that the AoA with the second electronic device (e.g., a TV) increases, the second electronic device (e.g., a TV) tracks the AoA trend in the tracking area and, when it leaves the tracking area, the second electronic device (e.g., a TV) may request UWB power off from the first electronic device C.

Referring to FIG. 18B, in Zone 2 (ranging & AoA tracking area), when the first electronic device D moves while maintaining a predetermined AoA pattern with the second electronic device (e.g., a TV), the AoA value AoA_{TV}_D has a pattern (d→d′→d″→d′→ . . . ), and the Ranging_{TV}_D may vary flexibly.

According to an embodiment, when the first electronic device D moves while maintaining a predetermined AoA pattern with the second electronic device (e.g., a TV), the first electronic device D and the second electronic device (e.g., a TV) may maintain a UWB connection if ranging_D is in the Region and the pattern is kept constant even when the AoA measurement value is out of the tracking area. According to an embodiment, the second electronic device (e.g., a TV) may request UWB off from the first electronic device D when the change trend of the AoA pattern is out of the ranging region (d→d′→d″→d′+n→d+m→d′+2n→d″+1→ . . . ) .

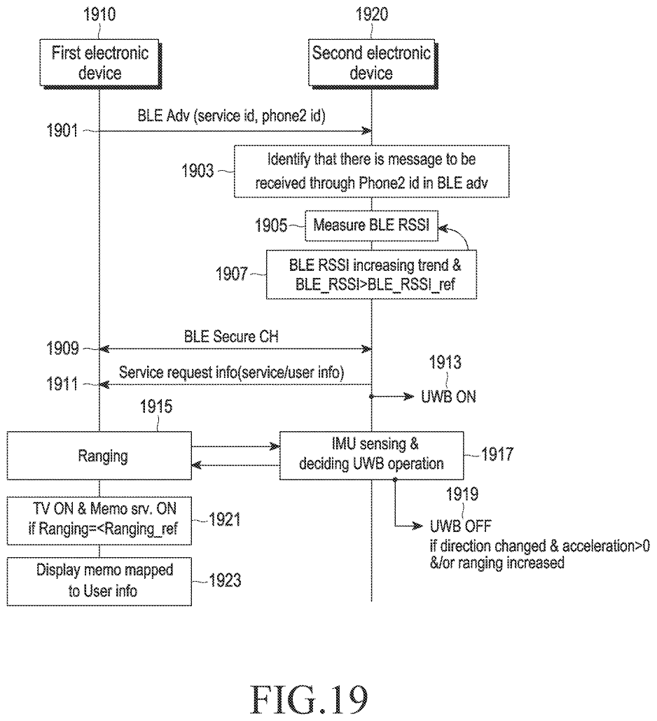

FIG. 19 illustrates a process in which an electronic device directly determines mobility based on a sensor according to an embodiment of the disclosure.

In FIG. 19, the second electronic device 1920 (e.g., a mobile phone) may directly determine mobility using the measured ranging information and IMU sensing information.

Referring to FIG. 19, in operation 1901, the first electronic device 1910 (e.g., a TV) may transmit a BLE advertisement message including a service id and a phone2 id to the second electronic device 1920 (e.g., a mobile phone). According to an embodiment, the phone2 id may be an identifier for the second electronic device 1920 (e.g., a mobile phone). According to an embodiment, the BLE advertisement message may include a recipient list. According to an embodiment, a plurality of BLE advertisement messages may be used.

In operation 1905, the second electronic device 1920 may measure the BLE RSSI. In operation 1907, the second electronic device 1920 may identify an increasing trend of BLE RSSI and whether the BLE RSSI value BLE_RSSI exceeds the threshold BLE_RSSI_ref.

In operation 1909, the first electronic device 1910 and the second electronic device 1920 are connected through a BLE secure channel (CH) and, in operation 1911, the second electronic device 1920 may transmit service request information including the service information and user information to the first electronic device 1910. In operation 1913, the second electronic device 1920 may turn on the UWB module. According to an embodiment, operation 1909 may be performed independently of operation 1905 and operation 1907, and may be performed immediately after operation 1903.

In operation 1915, the first electronic device 1910 may perform ranging and, in operation 1917, the second electronic device 1920 may obtain sensing information using an IMU sensor and determine a UWB operation. According to an embodiment, the first electronic device 1910 and the second electronic device 1920 may transmit and/or receive information obtained in operation 1915 and 1917. According to an embodiment, a long ranging period may be set when acceleration=0.

In operation 1919, the second electronic device 1920 may turn off the UWB module. According to an embodiment, the second electronic device 1920 may turn off the UWB module when the direction is changed and the acceleration is larger than 0. According to an embodiment, when the ranging value increases, the second electronic device 1920 may turn off the UWB module.

In operation 1921, when the ranging value with the second electronic device 1920 is smaller than or equal to the threshold Ranging_ref, the first electronic device 1910 may turn on the display and display the service information (e.g., a note).

In operation 1923, the first electronic device 1910 may display the service information (e.g., a note) mapped to the user information on the display. According to an embodiment, the user information may be the same as that transmitted from the second electronic device 1920 in operation 1911.

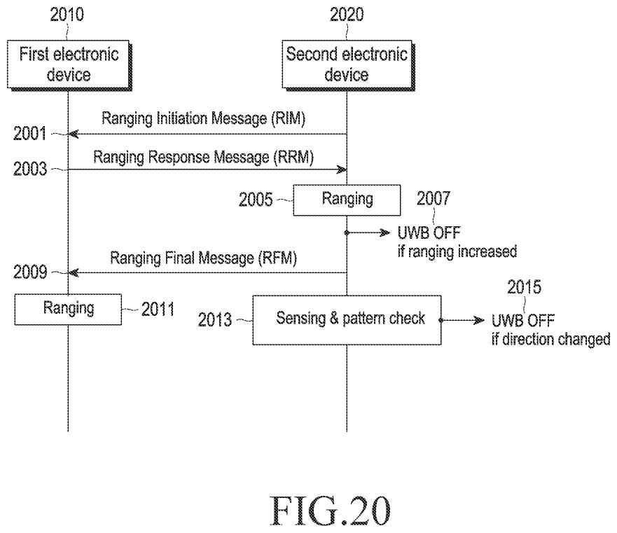

FIG. 20 illustrates a process of turning off UWB based on ranging and sensing according to an embodiment of the disclosure.

Referring to FIG. 20, in operation 2001, the first electronic device 2010 may receive a ranging Initiation message (RIM) from the second electronic device 2020. In operation 2003, the first electronic device 2010 may transmit a ranging response message (RRM) to the second electronic device 2020. In operation 2003, the first electronic device 2010 may transmit the reply time (response time) to the second electronic device 2020. In operation 2003, the first electronic device 2010 may include the reply time (response time) in the RRM and transmit the same to the second electronic device 2020. In this case, the reply time (response time) may be a response time of the first electronic device 2020 with respect to the RIM.

In operation 2005, the second electronic device 2020 may perform ranging. When the ranging increases in operation 2007, the second electronic device 2020 may turn off the UWB module.

In operation 2009, the second electronic device 2020 may transmit a ranging final message (RFM) to the first electronic device 2010. In operation 2009, the second electronic device 2020 may transmit the reply time (response time) to the first electronic device 2010. In this case, the reply time may be a response time of the second electronic device 2020 with respect to the RRM.

In operation 2011, the first electronic device 2010 may perform ranging and, in operation 2013, the second electronic device 2020 may perform sensing and pattern check. When it is determined that the direction of the second electronic device 2020 is changed in operation 2015, the second electronic device 2020 may turn off the UWB module.

According to an embodiment, if the ranging is not increased, the first electronic device 2010 and the second electronic device 202 may repeatedly perform ranging and/or sensing.

According to some configurations, the following modified operations are also possible.

In operation 2001, the first electronic device 2010 may receive the ranging initiation message (RIM) from the second electronic device 2020.

In operation 2003, the first electronic device 2010 may transmit the ranging response message (RRM) to the second electronic device 2020. After operation 2003, the second electronic device 2020 may transmit the round trip time to the first electronic device 2010. In this case, the round trip time may be included and transmitted in a measurement report message (MRM). Thereafter, the first electronic device 2010 may perform ranging using the round trip time received from the second electronic device 2020. In this case, when the ranging increases, the first electronic device 2020 may turn off the UWB module.

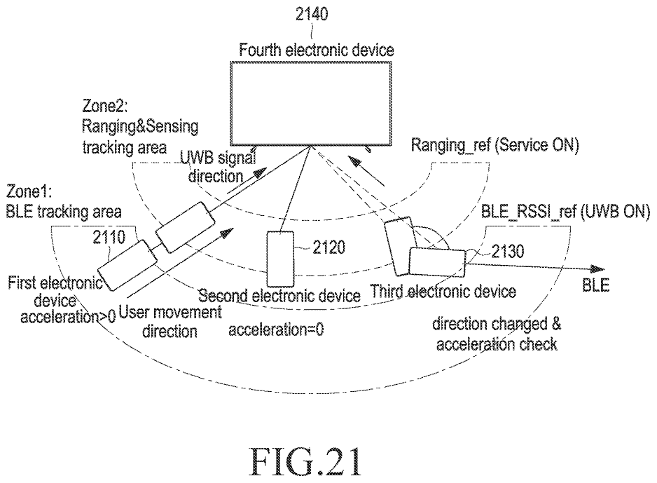

FIG. 21 is a view illustrating a process of determining the mobility of an electronic device based on a sensor according to an embodiment of the disclosure.

Referring to FIG. 21, the first electronic device 2110 may directly determine mobility using the measured ranging information and IMU sensing information, and as a result of the determination, it may be identified that the first electronic device 2110 approaches the fourth electronic device 2140 at a positive acceleration (>0).

The second electronic device 2120 may directly determine mobility using the measured ranging information and IMU sensing information, and may identify that it is in a stopped state (acceleration=0) as a result of the determination. According to an embodiment, the second electronic device 2120 may increase the UWB ranging period to reduce power consumption.

The third electronic device 2130 may directly determine mobility using the measured ranging information and IMU sensing information, and as a result of the determination, may identify that there is a movement and the direction has been changed (direction changed, acceleration>0), and the distance from the fourth electronic device 2140 increases (ranging ↑). According to an embodiment, the third electronic device 2130 may turn off the UWB module.

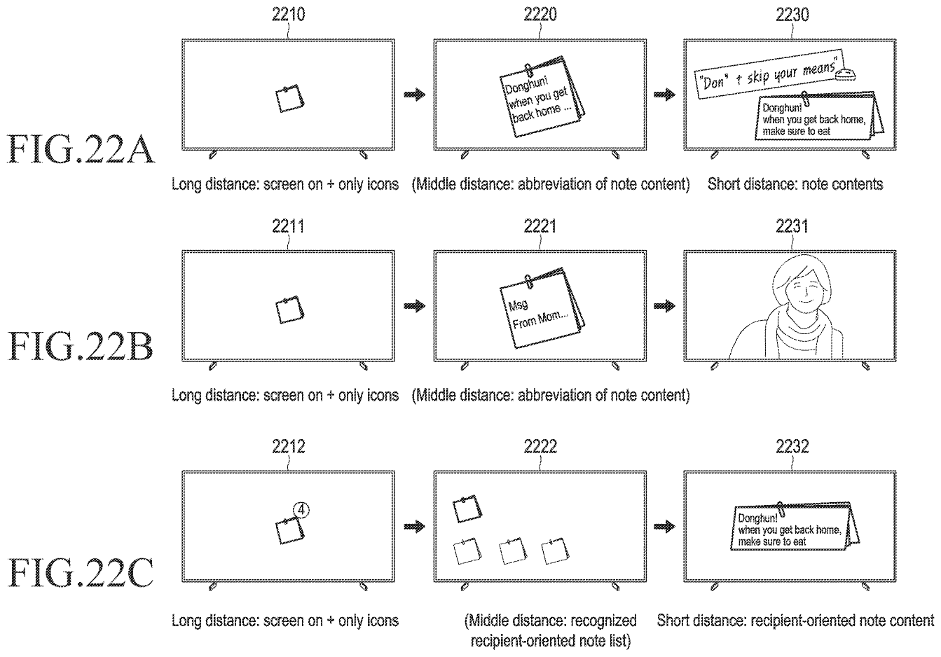

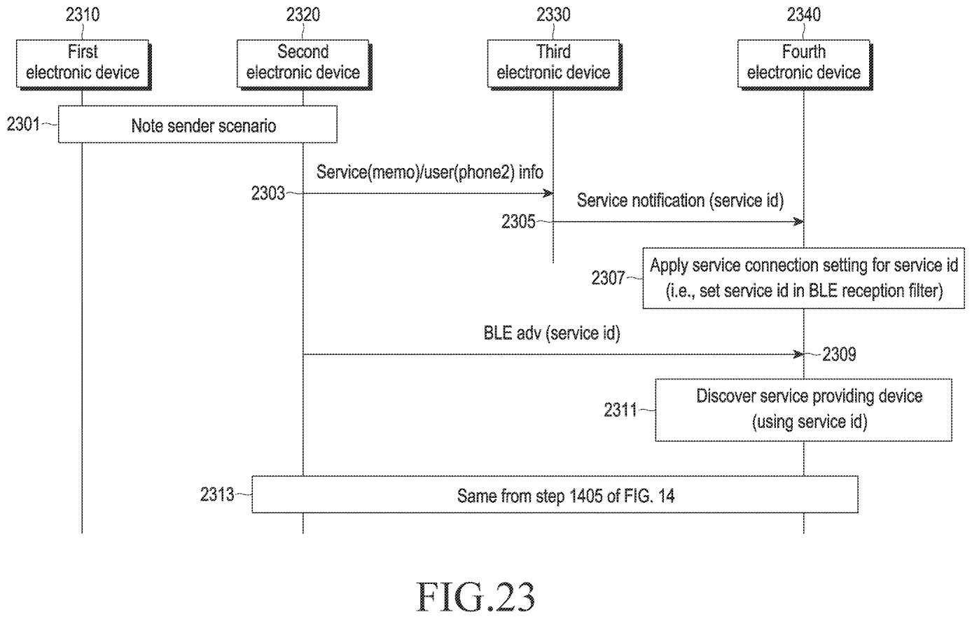

FIGS. 22A, 22B, and 22C illustrate an example of a UI according to UWB ranging results between electronic devices according to an embodiment of the disclosure.

The UI displayed on the second electronic device may be set differently according to the UWB ranging result measured between the first electronic device (e.g., a mobile phone) and the second electronic device (e.g., a TV).

Referring to FIG. 22A, when the distance between the first electronic device and the second electronic device is a long distance according to the UWB ranging result between the first electronic device (e.g., a mobile phone) and the second electronic device (e.g., a TV), the display screen of the second electronic device may be turned on and only the icon may be displayed (2210). According to the UWB ranging result, when the distance between the first electronic device and the second electronic device is a middle distance, the note content may be abbreviated on the display screen of the second electronic device (2220). According to the UWB ranging result, when the distance between the first electronic device and the second electronic device is a short distance, all of the note content may be displayed on the display screen of the second electronic device (2230).

Referring to FIG. 22B, when the distance between the first electronic device and the second electronic device is a long distance according to the UWB ranging result between the first electronic device (e.g., a mobile phone) and the second electronic device (e.g., a TV), the display screen of the second electronic device may be turned on and only the icon may be displayed (2211). According to the UWB ranging result, when the distance between the first electronic device and the second electronic device is a middle distance, the note content may be abbreviated on the display screen of the second electronic device (2221). According to the UWB ranging result, when the distance between the first electronic device and the second electronic device is a short distance, other content provided by the first electronic device may be displayed on the display screen of the second electronic device (2231).

Referring to FIG. 22C, when the distance between the first electronic device and the second electronic device is a long distance according to the UWB ranging result between the first electronic device (e.g., a mobile phone) and the second electronic device (e.g., a TV), the display screen of the second electronic device may be turned on, and icons and information (e.g., 4) about the number of icons may be displayed (2212). When the distance between the first electronic device and the second electronic device is a middle distance according to the UWB ranging result, a note list directed to the recognized recipient (or target device) may be displayed on the display screen of the second electronic device (2222). According to the UWB ranging result, when the distance between the first electronic device and the second electronic device is a short distance, note content directed to the recipient (or the target device) may be displayed on the display screen of the second electronic device (2232).

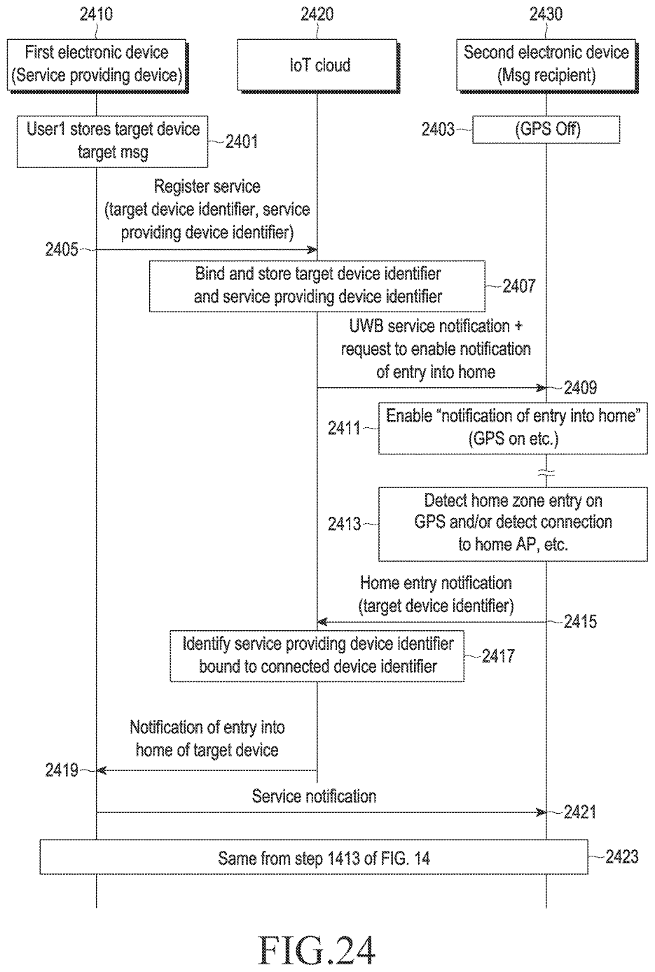

FIG. 23 illustrates a process of providing a service notification using a cloud according to an embodiment of the disclosure.

In FIG. 23, the first electronic device 2310 (e.g., a mobile phone) may make a reception configuration in the fourth electronic device 2340 by notifying the fourth electronic device 2340 (e.g., a mobile phone) that there is a reception service through the second electronic device 2320 (e.g., a TV) or the third electronic device 2330 (e.g., a cloud). In this case, when BLE advertising is performed in the second electronic device 2320 (e.g., a TV), additional information other than the service ID is not required, so there is an advantage in terms of advertising message size.

In operation 2301, the first electronic device 2310 (e.g., a mobile phone) and the second electronic device 2320 (e.g., a TV) may execute the note sender scenario (all or some of 1101 to 1113 of FIG. 11) shown in FIG. 11.

In operation 2303, the second electronic device 2320 (e.g., a TV) may transmit the service information (e.g., a note) and/or user information (phone2 ID) to the third electronic device 2330 (e.g., a cloud).

In operation 2305, the third electronic device 2330 (e.g., a cloud) may transmit a service notification including the service id to the fourth electronic device 2340 (e.g., a mobile phone).

In operation 2307, the fourth electronic device 2340 (e.g., a mobile phone) may apply the service connection setting for the service id (e.g., setting the service id to the BLE reception filter).

In operation 2309, the second electronic device 2320 (e.g., a TV) may broadcast a BLE advertisement message including the service id. In operation 2309, the fourth electronic device 2340 (e.g., a mobile phone) may receive a broadcast BLE advertisement message from the second electronic device 2320 (e.g., a TV).

In operation 2311, the fourth electronic device 2340 (e.g., a mobile phone) receiving the BLE advertisement message may discover the service providing device using the service id.

In operation 2313, the second electronic device 2320 (e.g., a TV) and the fourth electronic device 2340 (e.g., a mobile phone) may perform operations (all or some of 1405 to 1423) from step 1405 (BLE connection establishment) of FIG. 14.

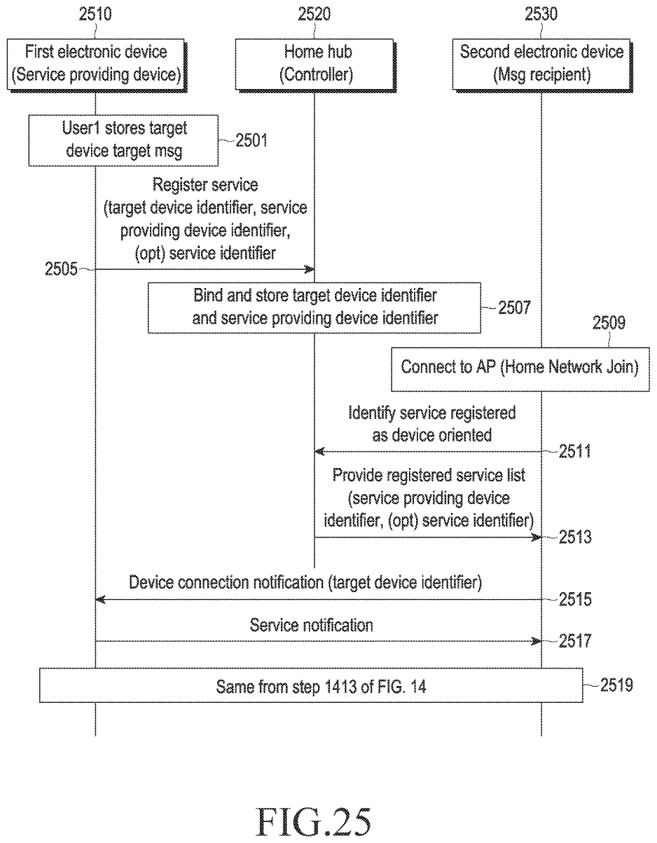

FIG. 24 illustrates a process of detecting a service and an area using an IoT cloud according to an embodiment of the disclosure.

There is a possibility that the second electronic device 2430 receiving a message in FIG. 24 keeps the GPS off for the purposes of privacy or battery consumption. In this case, when the first electronic device 2410, which is a service providing device, registers target device-oriented service information (e.g., a note) in an external electronic device (e.g., a TV), it may register the service in the IoT cloud 2420 for synchronization and pre-work to detect the entry into the home of the target device using the IoT cloud 2420.

Referring to FIG. 24, in operation 2401, the first electronic device 2410 may store a target device target message msg in response to a user input. In operation 2403, the second electronic device 2430 may turn off the GPS function.

In operation 2405, the first electronic device 2410 may transmit a service registration message including a target device identifier and a service providing device identifier to the IoT cloud 2420. In operation 2407, the IoT cloud 2420 may bind and store the target device identifier and the service providing device identifier.

In operation 2409, the IoT cloud 2420 may request the second electronic device 2430 to enable a UWB service notification and a notification function upon entry into the Home. In operation 2411, the second electronic device 2430 may activate a “notify upon entry into home” (such as GPS On). In operation 2413, the second electronic device 2430 may perform home zone entry detection and/or home AP connection detection on GPS.

In operation 2415, the second electronic device 2430 may transmit a Home entry notification including a target device identifier to the IoT cloud 2420. In operation 2417, the IoT cloud 2420 may identify the service providing device identifier bound to the connected device identifier.

In operation 2419, the IoT cloud 2420 may transmit a home entry notification of the target device including the target device identifier to the first electronic device 2410. In operation 2421, the first electronic device 2410 may transmit a service notification to the second electronic device 2430.

In operation 2423, the first electronic device 2410 and the second electronic device 2430 may perform operations (all or some of 1413 to 1423) from step 1413 (service request) of FIG. 14.

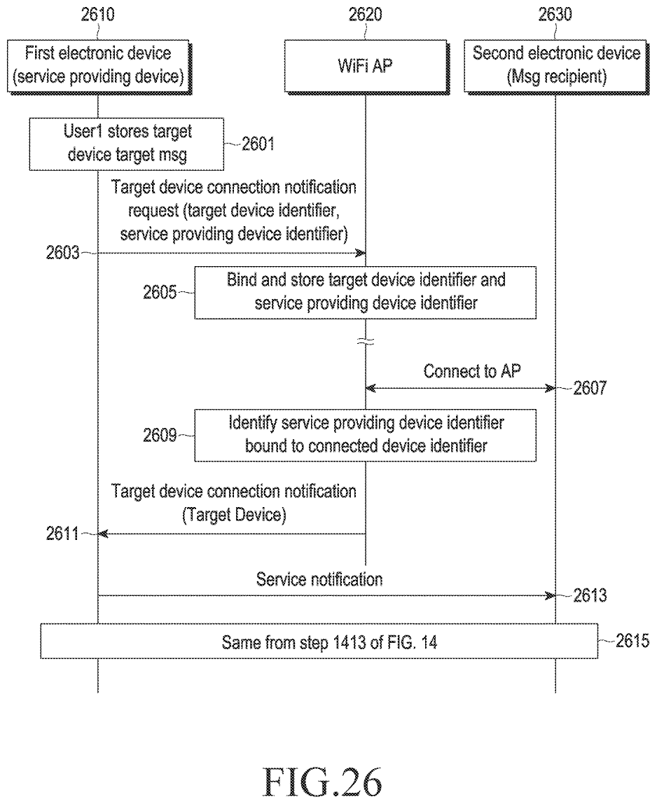

FIG. 25 illustrates a process of detecting approach of an electronic device using a hub according to an embodiment of the disclosure.

In FIG. 25, the first electronic device 2510 which is a service providing device and the second electronic device 2530 which is a message (msg) recipient may utilize the home hub 2520 which performs a controller function without using the Iot cloud.

Referring to FIG. 25, in operation 2501, the first electronic device 2510 may store a target device target message msg in response to a user input.

In operation 2505, the first electronic device 2510 may transmit a service registration message including a target device identifier and a service providing device identifier to the home hub 2520. According to an embodiment, the service registration message may further include a service identifier.

In operation 2507, the home hub 2520 may bind and store the target device identifier and the service providing device identifier.

In operation 2509, the second electronic device 2530 may be connected to an AP (Home Network Join). In operation 2511, the second electronic device 2530 may send a request for identifying whether there is a device-oriented registered service. In operation 2513, the second electronic device 2530 may receive a registered service list including a service providing device identifier from the home hub 2520. According to an embodiment, the registered service list may further include a service identifier.

In operation 2515, the second electronic device 2530 may transmit a device connection notification including a target device identifier to the first electronic device 2510.

In operation 2517, the first electronic device 2510 may transmit a service notification to the second electronic device 2530.

In operation 2519, the first electronic device 2510 and the second electronic device 2530 may perform operations (all or some of 1413 to 1423) from step 1413 (service request) of FIG. 14.

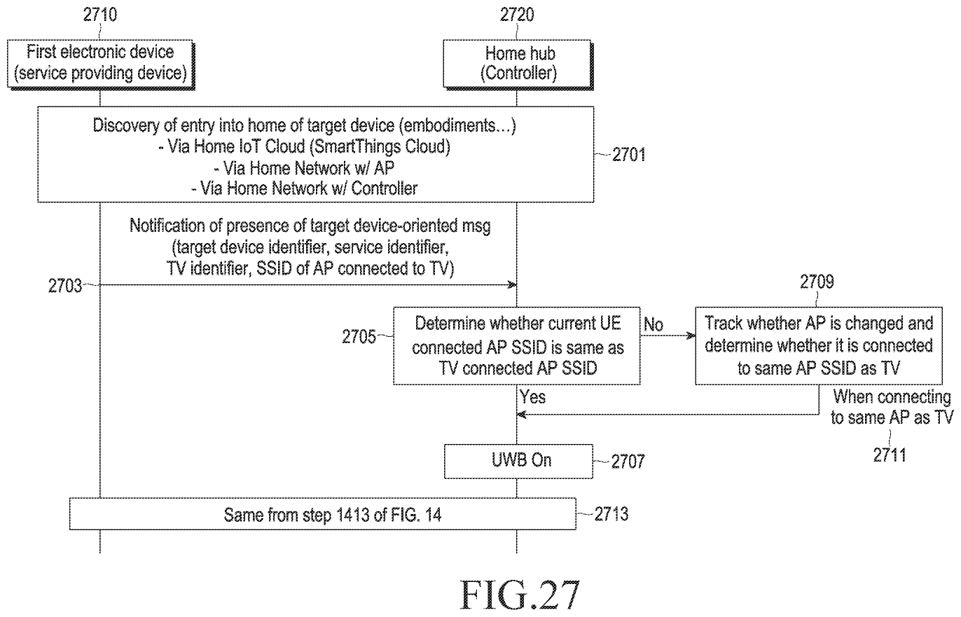

FIG. 26 illustrates a process of detecting approach of an electronic device using a Wi-Fi AP according to an embodiment of the disclosure.

In FIG. 26, the first electronic device 2610 which is a service providing device may provide a service notification to the second electronic device 2630 which is a message (msg) recipient using the Wi-Fi AP 2620, rather than the IoT cloud. According to an embodiment, the Wi-Fi AP 2620 may maintain a device list requiring a connection notification and, when connecting to a device in the list, transmit a connection notification to the first electronic device 2610, which is a service providing device.

Referring to FIG. 26, in operation 2601, the first electronic device 2610 may store a target device target message msg in response to a user input.

In operation 2603, the first electronic device 2610 may transmit a target device connection notification request including a target device identifier and a service providing device identifier to the Wi-Fi AP 2620.

In operation 2605, the Wi-Fi AP 2620 may bind and store the target device identifier and the service providing device identifier. In operation 2607, the Wi-Fi AP 2620 and the second electronic device 2630 may be connected to an AP.

In operation 2609, the Wi-Fi AP 2620 may identify the service providing device identifier bound to the connected device identifier.

In operation 2611, the Wi-Fi AP 2620 may transmit a target device connection notification including a target device identifier to the first electronic device 2610. In operation 2613, the first electronic device 2610 may transmit a service notification to the second electronic device 2630.

In operation 2615, the first electronic device 2510 and the second electronic device 2630 may perform operations (all or some of 1413 to 1423) from step 1413 (service request) of FIG. 14.

FIG. 27 illustrates a process in which an electronic device determines whether to perform UWB communication using Wi-Fi AP connection information according to an embodiment of the disclosure.

In FIG. 27, it is assumed that the second electronic device 2720, which is a target device, is pre-connected to the home network. UWB ranging may be performed only when the first electronic device 2710 (e.g., a TV, refrigerator) which is a service providing device and the second electronic device 2720 which is a message recipient are connected to the same AP (in the case of a large house, a multi-AP network may be configured).

Referring to FIG. 27, the first electronic device 2710 may discover entry into the home of the second electronic device 2720 which is a target device (FIGS. 24 to 26). According to an embodiment, the first electronic device 2710 may discover entry into the home of the second electronic device 2720, which is a target device, through the home IoT cloud (e.g., SmartThings Cloud). According to an embodiment, the first electronic device 2710 may discover entry into the home of the second electronic device 2720, which is a target device, through the home network including the AP. According to an embodiment, the first electronic device 2710 may discover entry into the home of the second electronic device 2720, which is a target device, through the home network including the controller.

In operation 2703, the first electronic device 2710 may transmit a notification that there is a target device-oriented message Msg to the second electronic device 2720 through a Wi-Fi (IP) or a cloud service. The notification may include at least one of the target device identifier, the service identifier, the TV identifier, and the SSID of the TV-connected AP.

In operation 2705, the second electronic device 2720 may determine whether the currently connected AP SSID is the same as the AP SSID connected to the first electronic device 2710.

According to an embodiment, when the AP SSID currently connected to the second electronic device 2720 is the same as the AP SSID connected to the first electronic device 2710, the second electronic device 2720 may turn on the UWB module in operation 2707.

According to an embodiment, if the AP SSID currently connected to the second electronic device 2720 is not the same as the AP SSID connected to the first electronic device 2710, in operation 2709, the second electronic device 2720 may track whether the AP is changed and determine whether the AP SSID is connected to the first electronic device 2710. When the second electronic device 2720 and the first electronic device 2710 are connected to the same AP SSID in operation 2711, the second electronic device 2720 may turn on the UWB module in operation 2707.

In operation 2713, the first electronic device 2710 and the second electronic device 2720 may perform operations (all or some of 1413 to 1423) from step 1413 (service request) of FIG. 14.

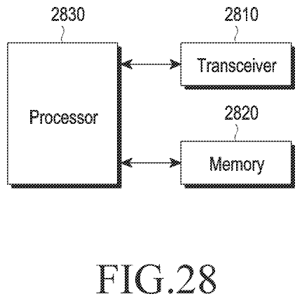

FIG. 28 illustrates a structure of an electronic device according to embodiments of the disclosure.

The electronic device of FIG. 28 may be any one of the electronic devices described with reference to FIGS. 1 to 27. Referring to FIG. 28, an electronic device may include a transceiver 2810, memory 2820, and a processor 2830. The processor 2830 may be referred to as a controller.

The transceiver 2810, the processor 2830, and the memory 2820 of the electronic device may operate according to the communication method of the electronic devices described above. However, the components of the electronic device are not limited to the above-described examples. For example, the electronic device may include more or fewer components than the above-described components. Further, the transceiver 2810, the processor 2830, and the memory 2820 may be implemented in the form of a single chip. The processor 2830 may include one or more processors.

The transceiver 2810 collectively refers to a receiver of the electronic device and a transmitter of the electronic device and may transmit and receive signals to/from another device. To that end, the transceiver 2810 may include a radio frequency (RF) transmitter for frequency-up converting and amplifying signals transmitted and an RF receiver for low-noise amplifying signals received and frequency-down converting the frequency of the received signals. However, this is merely an example of the transceiver 2810, and the components of the transceiver 2810 are not limited to the RF transmitter and the RF receiver.

The transceiver 2810 may receive signals via a radio channel, output the signals to the processor 2830, and transmit signals output from the processor 2830 via a radio channel.

The memory 2820 may store programs and data necessary for the operation of the electronic device. Further, the memory 2820 may store control information or data that is included in the signal obtained by the electronic device. The memory 2820 may include a storage medium, such as ROM, RAM, hard disk, CD-ROM, and DVD, or a combination of storage media. Rather than being separately provided, the memory 2820 may be embedded in the processor 2830.

The processor 2830 may control a series of processes for the electronic device to be able to operate according to the above-described embodiments.

According to an embodiment of the disclosure, a first electronic device supporting ultra-wideband (UWB) communication comprises a transceiver 2810 and a controller 2830. The controller 2830 may receive, from a second electronic device, a Bluetooth low energy (BLE) advertisement message including an identifier of the first electronic device, identify whether there is service information displayed on the second electronic device and provided from a third electronic device to the first electronic device based on the BLE advertisement message, and control to transmit a service request message for the service information to the second electronic device based on distance information between the first electronic device and the second electronic device obtained through UWB ranging.

According to an embodiment of the disclosure, a second electronic device supporting ultra-wideband (UWB) communication comprises a transceiver 2810 and a controller 2830. The controller may receive service information to be provided to a first electronic device from a third electronic device through UWB communication, control to transmit a Bluetooth low energy (BLE) advertisement message including an identifier of the first electronic device, and receive a service request message for the service information from the first electronic device in response to the BLE advertisement message.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for operating a first electronic device supporting ultra-wideband (UWB) communication, the method comprising:
receiving, from a second electronic device, a Bluetooth low energy (BLE) advertisement message including an identifier of the first electronic device;
identifying whether there is service information displayed on the second electronic device and provided from a third electronic device to the first electronic device based on the BLE advertisement message; and
transmitting a service request message for the service information to the second electronic device.

2. The method of claim 1, wherein the service information is displayed on the second electronic device based on the service request message.

3. The method of claim 1, further comprising:
based on the first electronic device being located in a BLE tracking area, tracking a BLE received signal strength indicator (RSSI) to determine whether to turn on a UWB module in the first electronic device.

4. The method of claim 1, further comprising:
based on the first electronic device being located in a ranging and angle of arrival (AoA) tracking area, detecting whether the first electronic device approaches the second electronic device and/or a movement direction of the first electronic device using at least one of ranging and AoA.

5. The method of claim 1, further comprising:
based on the first electronic device being located in the ranging and AoA tracking area, determining whether to turn off a UWB module in the first electronic device using at least one of the ranging and the AoA.

6. The method of claim 1, wherein based on the first electronic device being located in a ranging and service area, a customized user interface (UI) according to a distance between the first electronic device and the second electronic device is displayed on the second electronic device.

7. A method for operating a second electronic device supporting ultra-wideband (UWB) communication, the method comprising:
receiving service information to be provided to a first electronic device from a third electronic device through UWB communication;
broadcasting a Bluetooth low energy (BLE) advertisement message including an identifier of the first electronic device; and
receiving a service request message for the service information from the first electronic device in response to the BLE advertisement message.

8. The method of claim 7, further comprising displaying the service information on the second electronic device based on the service request message.

9. The method of claim 7, further comprising:
after receiving the service request message from the first electronic device, starting to perform at least one of ranging and AoA with the first electronic device.

10. The method of claim 7, further comprising:
based on the first electronic device being located in a ranging and angle of arrival (AoA) tracking area, detecting whether the first electronic device approaches the second electronic device and/or a movement direction of the first electronic device using ranging and AoA.

11. The method of claim 7, further comprising:
based on the first electronic device being located in the ranging and AoA tracking area, determining whether to turn off a UWB module in the first electronic device using at least one of the ranging and the AoA; and
when the second electronic device determines to turn off the UWB module in the first electronic device, transmitting a message for requesting to turn off the UWB module to the first electronic device.

12. The method of claim 7, further comprising:
based on the first electronic device being located in a ranging and service area, displaying a customized user interface (UI) according to a distance between the first electronic device and the second electronic device.

13. A first electronic device supporting ultra-wideband (UWB) communication, the first electronic device comprising:
a transceiver; and
a controller,
wherein the controller is configured to:
receive, from a second electronic device, a Bluetooth low energy (BLE) advertisement message including an identifier of the first electronic device,
identify whether there is service information displayed on the second electronic device and provided from a third electronic device to the first electronic device based on the BLE advertisement message, and
control to transmit a service request message for the service information to the second electronic device based on at least one of an increasing trend of a BLE received signal strength indicator (RSSI) and whether the BLE RSSI value exceeds a threshold based on the BLE advertisement message.

14. The first electronic device of claim 13, wherein the controller is configured to:
based on the first electronic device being located in a ranging and angle of arrival (AoA) tracking area, detect whether the first electronic device approaches the second electronic device and/or a movement direction of the first electronic device using at least one of ranging and AoA.

15. A second electronic device supporting ultra-wideband (UWB) communication, the second electronic device comprising:
a transceiver; and
a controller,
wherein the controller is configured to:
receive service information to be provided to a first electronic device from a third electronic device through UWB communication,
control to broadcast a Bluetooth low energy (BLE) advertisement message including an identifier of the first electronic device, and
receive a service request message for the service information from the first electronic device in response to the BLE advertisement message.
